(19) United States
(12) Patent Application Publication
(10) Pub. No.: US 2013/0266878 A1
(43) Pub. Date: Oct. 10, 2013

(54) HYDROGEN STORAGE SYSTEM INCLUDING A LITHIUM CONDUCTOR

(71) Applicants: John J. Vajo, West Hills, CA (US); Ping Liu, Irvine, CA (US)

(72) Inventors: John J. Vajo, West Hills, CA (US); Ping Liu, Irvine, CA (US)

(73) Assignee: GM GLOBAL TECHNOLOGY OPERATIONS LLC, Detroit, MI (US)

(21) Appl. No.: 13/438,948

(22) Filed: Apr. 4, 2012

(51) Int. Cl. C01B 3/04; H01M 8/06; C01B 3/58; C01B 3/56; C09K 3/00

(52) U.S. Cl. 429/421; 423/648.1; 252/182.11; 252/182.32; 252/182.35; 252/182.34; 252/182.33

(57) ABSTRACT

A multiphase hydrogen storage material comprises a lithium compound and a lithium conductor. The hydrogen storage material is capable of undergoing hydrogenation and dehydrogenation cycles during which the rate of lithium transport is enhanced by the presence of the lithium conductor. A solid state hydrogen storage device and a process of storing and supplying hydrogen are also disclosed.

### TECHNICAL FIELD

The field to which the disclosure generally relates includes hydrogen storage material, process, and device.

### BACKGROUND

In addition to being stored as compressed hydrogen gas or cryogenic hydrogen liquid, hydrogen can be stored in and produced from certain solid compounds that are able to undergo hydrogenation (i.e., taking in hydrogen) and dehydrogenation (i.e., releasing hydrogen) reactions reversibly. A solid material capable of generating hydrogen under appropriate temperature and pressure offers a low pressure and light-weight option as a fuel source for hydrogen fuel cells and other hydrogen-consuming devices.

Various compositions comprising different metal hydrides have been explored as solid storage materials for hydrogen. Most of such materials have high dehydrogenation temperatures and/or un-desirable kinetic rate of hydrogenation or dehydrogenation. The mechanism and kinetic behaviors of hydrogenation and dehydrogenation of such solid materials have not been fully understood. An observed behavior in one metal hydride material does not always occur in another metal hydride.

### SUMMARY OF EXEMPLARY EMBODIMENTS OF THE INVENTION

A multiphase hydrogen storage material comprises a lithium containing metal hydride and a lithium conductor. The hydrogen storage material is capable of undergoing hydrogenation and dehydrogenation cycles during which the rate of lithium transport within the hydrogen storage material is enhanced by the lithium conductor. A solid-state hydrogen storage device can be produced using the multiphase hydrogen storage material.

A process of storing and supplying hydrogen comprises: (a) providing a multiphase material capable of undergoing dehydrogenation and hydrogenation cycles, where the multiphase material comprises providing at least a lithium containing metal hydride; (b) providing a lithium conductor having a Log(σ·T) value of at least −6 at 100° C., where σ is lithium ionic conductivity in ohms⁻¹cm⁻¹ and T is absolute temperature in Kelvin; and (c) combining the multiphase material with the lithium conductor by ball-milling, mechanochemical processing, planetary milling, vibro-milling, vapor phase deposition, dissolution-precipitation, dissolution-evaporation, solution-crystallization, melt mixing, or sputtering deposition method such that the lithium transport rate of the multiphase material during hydrogenation and/or dehydrogenation is enhanced.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### DETAILED DESCRIPTION OF EXEMPLARY EMBODIMENTS

The following description of the embodiment(s) is merely exemplary in nature and is in no way intended to limit the invention, its application, or uses.

The hydrogen storage material according to one embodiment of the invention comprises at least two different phases of materials. The different phases of the hydrogen storage material have different lattice structures and/or chemical compositions. The hydrogen storage material may comprise a mixture, for example, of different chemical components. The mixture may be formed in such a manner that there are multiple phases of materials having different chemical compositions. The hydrogen storage material may have different crystalline regions with different lattice structures, or the hydrogen storage material may comprise a mixture of crystalline and amorphous regions within the material. Each of the chemical compositions or regions may exist as an individual phase with its size ranging from several thousand micrometers to several nanometers. The material having at least two different phases is herein referred to as a multiphase material.

The hydrogen storage material may be “loaded” with releasable hydrogen to form a hydrogenated state, and be depleted with releasable hydrogen at its dehydrogenated state. The loading and releasing of hydrogen gas in the alternating hydrogenation and dehydrogenation processes is herein referred to as the hydrogen cycle. The hydrogenated state and dehydrogenated state may have different chemical compositions and different crystalline structures. The hydrogen storage material may include mixed hydrogenated and dehydrogenated states of materials when only part of releasable hydrogen is removed.

At least the hydrogenated state of the hydrogen storage material comprises at least one metal hydride. The metal hydride may be selected from at least one of ionic, covalent, and complex hydrides. Ionic hydrides typically contain metal cations and negatively charged hydrogen ions. Examples of ionic hydrides include, but not limited to, lithium hydride, sodium hydride, calcium hydride, and potassium hydride. Alkaline metal amides, such as lithium amide, sodium amide, and potassium amide, are also included in the ionic hydride category in this application. In covalent hydrides, the metal-hydrogen bond is effected through a common electron pair between the metal and hydrogen atoms. Examples of covalent hydrides include, but are not limited to, beryllium hydride, magnesium hydride, aluminum hydride, zirconium hydride, silane, borane, ammonia borane, aminoboranes, and germane. The complex hydrides are a large group of compounds in which hydrogen is combined in a fixed proportion with at least two other constituents, generally metal elements. A complex metal hydride can be represented by a typical chemical formula: M¹(M²Hₓ)ₙ, where M¹, M² are two different elements and n and x are each numbers that correspond to the balance of electroneutrality of the molecule. M¹ may be one of Li, Na, K, Ca, Mg, Sr, La, and Ti, and M² may be one of Al, B, Ni, Fe and Ga. A complex hydride typically exhibits ionic bonding between a positive metal ion M¹ with molecular anions containing the hydride (M²Hₓ) portion. In such materials the hydrogen is bonded with significant covalent character to the second metal M² or metaloid atoms. Examples of complex hydrides include, but are not limited to, lithium borohydride (LiBH₄), magnesium borohydride (Mg(BH₄)₂), calcium borohydride (Ca(BH₄)₂), potassium borohydride (KBH₄), aluminum borohydride (Al(BH₄)₃), beryllium borohydride (BeBH₄), lithium aluminum hydride (LAlN, sodium aluminum hydride (NaAlH₄), magnesium aluminum hydride (Mg(AlH₄)₂), calcium aluminum hydride (Ca(AlH₄)₂), potassium aluminum hydride (KAlH₄), Mg₂FeH₆, Mg₂NiH₄, and metallic hydrides such as, but not limited to, TiFeH₂ and LaNi₅H₆. The hydrogen storage material may comprise one or more of the complex hydrides or metallic hydrides described above.

A typical hydride-containing hydrogen storage material can contain several forms hydrogen at its different hydrogenation, storage, and dehydrogenation stages. A solid solution of hydrogen atoms can exist in a metal lattice or coexist with a monohydride phase of the hydride (e.g., ZH, where Z is a hydride-forming metal or other element). A monohydride phase and a dihydride phase can each exist alone. Both monohydride phases and dihydride phases (e.g., ZH₂) can coexist.

The hydrogen storage material may comprise a mixture of at least two different hydrides having different dehydrogenation temperatures or thermal decomposition temperatures. Mixtures of two different hydrides can exhibit lower dehydrogenation temperatures and faster kinetic rates than each of its constituent hydrides. One such example is the mixture of MgH₂ and LiBH₄. When these compounds are combined, the free energy is less than the respective free energy for hydrogen release for the individual compounds. Combination of a stable hydride and a destabilizing hydride is described in US Patent Application Publication numbers 20060013766 and 20060013753, which are incorporated herein by references in their entirety. Any combination of two or more of metal hydrides described above may be used to create a multiphase hydrogen storage material. In one embodiment, the hydrogen storage material comprises at least one stable hydride selected from the group consisting of lithium borohydride (LiBH₄), lithium aluminum hydride (LiAlH₄), sodium borohydride (NaBH₄), magnesium borohydride Mg(BH₄)₂, and any mixtures thereof. The hydrogen storage material may further comprise a simple hydride, such as an ionic or covalent metal hydride described above, as a destabilizing hydride to be mixed with a stable hydride.

The hydrogen storage material generally comprises lithium and one or more of other light elements such as hydrogen, beryllium, boron, carbon, nitrogen, sodium, magnesium, silicon, calcium, and aluminum. A compound comprising lithium in its chemical composition is herein referred to as a lithium compound. When fully hydrogenated, the hydrogen storage material typically has a releasable hydrogen content of at least 3%, at least 5%, or at least 8% by weight. Lithium element in the chemical composition not only affords light weight and high gravimetric storage density of hydrogen, but also provides possible desirable kinetic rates in the chemical and physical processes of hydrogenation and dehydrogenation, due to lithium's small atomic mass and high mobility.

The hydrogen storage material may comprise, for example, a lithium compound in the form of a lithium containing metal hydride at least in its hydrogenated state. Lithium containing metal hydrides may include, but are not limited to, lithium hydride, lithium aluminum hydride, lithium borohydride, and lithium amide. Other lithium compounds may be included in the hydrogen storage material in addition to the lithium containing hydride. Other lithium compounds may include, but are not limited to, lithium metals or lithium alloys. During the dehydrogenation process, the lithium-containing hydride undergoes a chemical reaction to release hydrogen gas. The dehydrogenation reactions of several exemplary lithium-containing hydrides are shown in the following chemical reaction schemes 1-3

LiBH₄→LiH+B+1.5H₂ [1]

LiAlH₄→LiH+Al+1.5H₂ [2]

LiNH₂+LiH→Li₂NH+H₂ [3]

The above reactions can be reversed in a hydrogenation process under appropriate hydrogen pressure and temperature. In solid state reactions as shown above, the rate of reaction and temperature of dehydrogenation and hydrogenation can be affected by the transport rate of chemical constituent of different species involved in the reactions, in addition to rates of recombinative hydrogen desorption and hydrogen transport through the solid state material matrix. Although the Applicant does not wish to be bound to or by any particular theories, it is believed that the lithium transport in the hydrogen storage material according to the invention plays a significant role in the kinetics of hydrogenation and dehydrogenation. The Applicant thus recognizes that the rate of hydrogenation and/or dehydrogenation can be improved by enhancing the transport rate of lithium element or lithium ion in the hydrogen storage material, particularly the lithium transport rate between different phases within the multiphase material.

The hydrogen storage material may comprise a lithium conductor. Any lithium conductors that can enhance the transport rate of lithium element or lithium ion may be used. The lithium conductor may or may not contain a lithium element or lithium ion. The lithium conductor may have a Log(σ·T) value of at least −6, −4, or −2 at 100° C., where σ is lithium ionic conductivity in the unit of ohm⁻¹·cm⁻¹, and T is absolute temperature in Kelvin. Exemplary lithium conductors include, but not limited to, Lil (lithium iodide), (Li₄SiO₄)ₓ/(Li₃PO₄)₁₋ₓ solid solution (x is a number between 0 and 1), Li₄SiO₄, Li/β-Al₂O₃ mixture, LiAlCl₄ (lithium aluminum chloride), LiAlF₄ (lithium aluminum fluoride), Li₂Ti₃O₇, LiAlSiO₄ (lithium aluminum silicate), Li₉SiAlO₆, Li₈TaO₆, Li₈NbO₆, Li₃InBr₆, Li₃ₓLa_{0.66-x}TiO₃ (0.03≦x≦0.167), TiO₂, V₂O₅, aluminum, Lithium aluminum alloy represented by the chemical formula Li₁₊ₓAl (−0.15≦x≦0.2), magnesium aluminum alloy, LiWO₂, LiMoO₂ and any combinations thereof. LiAlF₄ may be formed in-situ by milling or mixing LiF and AlF₃ together. Log(σ·T) values of several lithium conductors mentioned above are listed in Table 1 below.

TABLE 1
Log(σ · T) values of a few lithium conductors

| Lithium conductors | Log(σ · T) values, at 100° C. |
|---|---|
| LiI (lithium iodide) | −2.3 |
| LiAlCl₄ (lithium aluminum chloride) | −2.0 |
| (Li₄SiO₄)_{0.5}(Li₃PO₄)_{0.5} solid solution | −1 |
| Li₄SiO₄ | −6 |
| Li₂Ti₃O₇ | −2.2 |

The lithium conductor may be included in the hydrogen storage material at an amount less than about 50%, 20%, or 2% by weight.

The hydrogen storage material may further comprise a catalyst that can further enhance the rate of hydrogenation and/or dehydrogenation. Possible catalyst compositions, which may be used in concentrations from 0.1 to 10 atomic percent (based on the catalytic metal atom) include TiCl₃, TiHₓ (0.1≦x≦2), TiF₃, TiCl₂, TiCl₄, TiF₄, VCl₃. VF₃, VHₓ (0.1≦x≦2), NiCl₂, LaCl₃ and other similar transition metal compounds. Further examples of catalysts for the hydrogenation or dehydrogenation include halogen compounds or hydrides of scandium, chromium, manganese, iron, cobalt, copper, yttrium, zirconium, niobium, molybdenum, ruthenium, rhodium, palladium, cerium, neodymium, erbium, and platinum, as well as combinations of one or more of these metal elements in a chemical composition. The catalyst could be processed and incorporated into the hydrogen storage material by mechanical milling, precipitation from solution, dissolution-evaporation, crystallization, re-crystallization, vapor phase deposition, chemical transport, or sputter deposition process.

The hydrogen storage material may also comprise a hydride destabilizing agent that can lower the dehydrogenation temperature and/or the increase the rate of dehydrogenation of a hydride. Examples of a hydride destabilizing agent, include, but are not limited to, other hydrides, elements, magnesium compounds, nanoparticles of inorganic materials, oxides, or carbides. Other hydrides may include MgH₂ and the like. Elements may include silica, silicon, aluminum, copper, sulfur, potassium, or boron. Magnesium compounds may include MgF₂, MgS, MgSe, or the like. Nanoparticles of inorganic materials may include nanoparticles of oxides, hydroxides, halides, silicates, carbon, nitrides and metals. Those of skill in the art will appreciate that an oxide is any chemical compound which contains at least oxygen in its chemical formula and that a carbide is any chemical compound containing at least carbon in its chemical formula. The destabilization reactions of several exemplary lithium-containing hydrides are shown in the following chemical reaction schemes 4-6:

2LiBH₄+MgH₂→2LiH+MgB₂+4H₂ [4]

2LiBH₄+Al→2LiH+AlB₂+3H₂ [5]

2LiBH₄+MgF₂→2LiF+MgB₂+4H₂ [6]

The components and phases of the hydrogen storage material described above may be combined using various mixing and/or synthesizing processes to form the multiphase hydrogen storage material. Different components and phases of materials may be combined in ball-milling, mechanochemical processing, planetary milling, vibro-milling, vapor phase deposition, dissolution-precipitation, dissolution-evaporation, solution-crystallization, melt mixing, re-crystallization, solid state synthesis and/or sputtering deposition processes. The combination or mixing process may involve simple physical mixing, crystallization, or chemical reactions to form a multiphase material with a desired size for each of the phases. The combination may also involve diffusion of one chemical component from one phase to another, and formation of molecular solutions or alloys. Furthermore, chemical reactions between different components may also take place, for example, in a mechanochemical process where structural changes and chemical reactions occur at a high pressure generated in the material during milling. Numerous chemical reactions in metal—aluminum or boron—hydrogen systems have been carried out successfully in solid state under solvent-free conditions. Ti-catalyzed decompositions of LiAlH₄ at room temperature, for example, can be achieved upon mechanical milling. In another example, instead of using a transition-metal catalyzed alkali metal aluminum hydride (such as lithium aluminum hydride) in the hydrogen storage material, the starting materials used for their preparation in the form of alkali metal hydrides or alkali metals (especially NaH and Na), Al powder, transition-metal catalyst (such as titanium tetrabutylate) along with a lithium conductor can be employed. The complex aluminum hydride formed in one hydrogenation step from such starting materials are immediately functioning in the multiphase hydrogen storage material and has improved storage properties and kinetic rates. In yet another example, a mixture of LiBH₄ and MgF₂ is prepared having a molar ratio of 2:1 that reacts according to the above described chemical reaction scheme 6. The LiBH₄ is commercially available from Lancaster Synthesis, Inc. of Windham, N.H. (and is specified to be ≧.95% purity) and the MgF₂ is commercially available at 99.99% purity from Aldrich. The starting powders are mixed in the molar ratio 2LiBH₄:1 MgF₂ with 2 mole percent of a catalyst (TiCl₃), and 10% by weight of LiAlF₄ (lithium aluminum fluoride is a lithium conductor with a Log(σ·T) value of −3.5 at 25° C., which is estimated to be >−2.5 at 100° C.) added during milling. The materials are then high-energy ball milled for at least one hour in a Fritsch Pulversette 6 planetary mill at 400 rpm. The average particle diameter of the compound(s) remaining in the mill typically range from approximately 5 micrometers to about 15 micrometers. Optionally and alternatively, the individual constituents may be individually milled, if necessary, and mixed, or milled and mixed at the same time. Typical milling parameters using, for example, a Fritsch P6 planetary mill include: 400 rpm, 1 hour milling time, 80 cm³ hardened steel vessel, thirty 7 mm diameter Cr-steel balls, and 1.2 gram total sample mass. Where dry milling and mixing is not preferred for a combination of constituents, other practices such as solution-based methods (such as dissolution-precipitation, dissolution-evaporation, and solution-crystallization), or approaches based upon direct synthesis of nanoscale (1-100 nm) particles may be used to combine different components and phases for improved reaction kinetics. When LiAlCl₄ (with a melting point of about 140° C.) is selected as the lithium conductor, for example, the lithium conductor can be incorporated into the multiphase hydrogen storage material by melt blending at a temperature greater than 140° C., where the liquid LiAlCl₄ can be easily absorbed and distributed throughout the rest of components. To avoid unwanted agglomeration of nanoparticles during hydrogen cycles, it is possible to support individual particles in an inert matrix support or scaffold.

As appreciated'by one of ordinary skill in the art, the hydrogen storage material may initially comprise the dehydrogenated products or mixture, and may be subsequently hydrogenated, thereby cyclically releasing and storing hydrogen in accordance with the present invention. For example, in one embodiment, the starting materials comprising LiF, MgB₂, and a lithium conductor LiAlF₄ are milled together to form a multiphase material. The starting materials are exposed to hydrogen gas at an appropriate temperature and pressure, where they transform to LiBH₄ and MgF₂ in a hydrogenated state, and are able to subsequently and reversibly release and absorb hydrogen, as previously described above in reaction scheme 6.

A solid hydrogen storage and supply device may be manufactured by using the hydrogen storage material described above. The hydrogen storage material may be provided as a high surface area multiphase mixture. It can be loaded, for an example, into a microporous support structure (such as a macroporous aluminum foam structure) inside a solid container fitted with heating and cooling elements, along with other known temperature and pressure control elements. The device is insulated and sealed to prevent leakage or contact with environmental hazards. The device has a filling port to allow inflow of pressurized hydrogen to hydrogenate the hydrogen storage material at an appropriate temperature and pressure. The device may also have an outlet port that can be connected to a hydrogen fuel cell, a hydrogen battery, a hydrogen combustion engine, or other hydrogen-consuming devices. The outlet may include a pressure and temperature regulator to provide a controlled outflow of hydrogen gas to an external hydrogen-consuming device. The heat generated from a hydrogen-consuming device may be used to heat up the hydrogen storage material to maintain a desired rate of dehydrogenation (or hydrogen gas release). The heat produced by the hydrogen-consuming device may be transferred to the hydrogen storage material through a heat exchanger coil, heat conductive elements or other heat transfer apparatus known to an ordinary skill in the field.

The hydrogen storage and supply device may be used in military, aerospace, automotive, commercial, and consumer applications as stationary and mobile power sources, remote power source, low profile power source, primary and auxiliary fuel cell power supplies, and power source for combustion engines and consumer electronics.

The above description of embodiments of the invention is merely exemplary in nature and, thus, variations thereof are not to be regarded as a departure from the spirit and scope of the invention.

What is claimed is:

1. A multiphase hydrogen storage material comprising a lithium compound and a lithium conductor; said material being capable of undergoing hydrogenation and dehydrogenation cycles during which the rate of lithium transport is enhanced by the presence of said lithium conductor.

2. A multiphase hydrogen storage material as set forth in claim 1, wherein said lithium conductor has a Log(σ·T) value of −6 or greater at 100° C., wherein a is the lithium ionic conductivity in the unit of ohm⁻¹·cm⁻¹, and T is absolute temperature in Kelvin.

3. A multiphase hydrogen storage material as set forth in claim 2 wherein said lithium conductor has a Log(σ·T) value of −4 or greater at 100° C.

4. A multiphase hydrogen storage material as set forth in claim 2, wherein said lithium conductor has a Log(σ·T) value of −2 or greater at 100° C.

5. A multiphase hydrogen storage material as set forth in claim 2, wherein said lithium conductor comprises Lil (lithium iodide), (Li₄SiO₄)ₓ/(Li₃PO4)₁₋ₓ solid solution (x is a number between 0 and 1), Li/β-Al₂O₃ mixture, LiAlCl₄ (lithium aluminum chloride), LiAlF₄ (lithium aluminum fluoride), Li₂Ti₃O₇, LiAlSiO₄ (lithium aluminum silicate), Li₉SiAlO₆, Li₈TaO₆, Li₅NbO₆, Li₃InBr₆, Li₃xLa_{0.66-x}TiO₃ (0.03≦x≦0.167), TiO₂, V₂O₅, aluminum, Lithium aluminum alloy represented by the chemical formula Li₁₊ₓAl (−0.15≦x≦0.2), magnesium aluminum alloy, LiWO₂, LiMoO₂ or any combinations thereof.

6. A multiphase hydrogen storage material as set forth in claim 1, wherein said lithium compound is at least of one of a lithium-containing hydride selected from the group consisting of lithium hydride, lithium aluminum hydride, lithium borohydride, and lithium amide.

7. A multiphase hydrogen storage material as set forth in claim 1, wherein said lithium compound is at least one of a lithium metal or lithium alloy.

8. A multiphase hydrogen storage material as set forth in claim 1, wherein said lithium conductor is present at less than about 50% by weight based on the total weight of said hydrogen storage material.

9. A multiphase hydrogen storage material as set forth in claim 8, wherein said lithium conductor is present at less than about 20% by weight based on the total weight of said hydrogen storage material.

10. A multiphase hydrogen storage material as set forth in claim 8, wherein said lithium conductor is present at less than about 2% by weight based on the total weight of said hydrogen storage material.

11. A multiphase hydrogen storage material as set forth in claim 1 further comprising a metal hydride, wherein said metal hydride comprises an ionic hydride, a covalent hydride, a complex hydride or any mixtures thereof.

12. A multiphase hydrogen storage material as set forth in claim 11, wherein said ionic hydride is at least one of lithium hydride, sodium hydride, calcium hydride, potassium hydride, sodium amide and lithium amide; said covalent hydride is at least one of beryllium hydride, magnesium hydride, aluminum hydride, zirconium hydride, borane, ammonia borane, aminoboranes, silane, and germane; and said complex hydride is at least one of lithium borohydride (LiBH₄), magnesium borohydride (Mg(BH₄)), calcium borohydride (Ca(BH₄)), potassium borohydride (KBH₄), aluminum borohydride (Al(BH₄)₃), beryllium borohydride (BeBH₄), lithium aluminum hydride (LAlN, sodium aluminum hydride (NaAlH₄), magnesium aluminum hydride (Mg(AlH₄)₂), calcium aluminum hydride (Ca(AlH₄)₂), potassium aluminum hydride (KAlH₄), Mg₂FeH₆, Mg₂NiH₄, and metallic hydrides such as, but not limited to, TiFeH₂ and LaNi₅H₆.

13. A multiphase hydrogen storage composition as set forth in claim 11 further comprises a catalyst that is capable of increasing the rate of dehydrogenation of at least one of said metal hydrides, or lowering the dehydrogenation temperature of one of said metal hydrides.

14. A multiphase hydrogen storage material as set forth in claim 13, wherein said catalyst is one or more of TiCl₃, TiH₂, TiHₓ (0.1≦x≦2), TiF₃, TiCl₂, TiCl₄, TiF₄, VCl₃, VBr₃, VF₃, VHₓ (0.1≦x≦2), NiCl₂, LaCl₃, halogen compounds or hydrides of at least one of scandium, chromium, manganese, iron, cobalt, copper, yttrium, zirconium, niobium, molybdenum, ruthenium, rhodium, palladium, cerium, neodymium, erbium, and platinum.

15. A multiphase hydrogen storage material as set forth in claim 11 further comprising a hydride destabilizing agent, selected from the group consisting of at least one of other hydrides, elements, magnesium compounds, nanoparticles of inorganic materials, oxides, or carbides. A multiphase hydrogen storage material as set forth in claim 11 comprising at least one stable hydride and one destabilizing hydride.

16. A multiphase hydrogen storage material as set forth in claim 16, wherein the dehydrogenation temperature of said hydrogen storage material is lower than the dehydrogenation temperature of each of said individual hydrides.

17. A multiphase hydrogen storage material as set forth in claim 16, wherein said stable and destabilizing hydrides are lithium borohydride and magnesium hydride respectively.

18. A solid state hydrogen storage device comprising a multiphase hydrogen storage material as set forth in claim 1.

19. A process of storing and supplying hydrogen comprising:
a. Providing a multiphase material capable of undergoing dehydrogenation and hydrogenation cycles; said material comprising at least a hydride and lithium in its chemical composition;
b. Providing a lithium conductor having a Log(σ·T) value of at least −6 at 100° C., where σ is lithium ionic conductivity in ohms⁻¹cm⁻¹ and T is absolute temperature in Kelvin; and
c. Combining said multiphase material with said lithium conductor by ball-milling, mechanochemical processing, planetary milling, vibro-milling, vapor phase deposition, dissolution-precipitation, dissolution-evaporation, solution crystallization, melt mixing, re-crystallization, solid state synthesis or sputtering deposition method such that lithium transport rate during hydrogenation and/or dehydrogenation is enhanced due to the presence of said lithium conductor;

20. A process as set forth in claim 18, wherein said multiphase material comprises at two different metal hydrides, each having its distinct dehydrogenation temperature.

21. A process as set forth in claim 18, wherein said multiphase material further comprises a catalyst and/or a metal hydride destabilizing agent.

22. A process as set forth in claim 20, wherein said catalyst comprises a transition metal compound, and said metal hydride destabilizing agent comprises at least one of other hydrides, elements, magnesium compounds, nanoparticles of inorganic materials, oxides, or carbides.

23. A process as set forth in claim 18 further comprising heating the combined multiphase material and said lithium conductor to cause dehydrogenation of said multiphase material and generation of hydrogen gas; supplying said hydrogen gas to a hydrogen fuel cell or a hydrogen-consuming device; and optionally transferring heat generated from said fuel cell or said device to said multiphase material to help maintain a desired rate of dehydrogenation.
